(19) United States
(12) Patent Application Publication
(10) Pub. No.: US 2026/0287716 A1
(43) Pub. Date: Sep. 24, 2026

(54) IMAGING SUB-ASSEMBLY FOR VEHICLE AND METHOD OF ASSEMBLING VEHICLE

(71) Applicant: Honda Motor Co., Ltd., Tokyo (JP)

(72) Inventors: Timothy J. RUPP, Dublin, OH (US); Connor ISINGS, Columbus, OH (US)

(21) Appl. No.: 19/084,693

(22) Filed: Mar. 19, 2025

(51) Int. Cl. G01S 7/481; G01S 13/931; G01S 17/931; H04N 23/57

(52) U.S. Cl. CPC G01S 7/4813; G01S 17/931; G01S 13/931; G01S 2013/9324; H04N 23/57

(57) ABSTRACT

An imaging sub-assembly for a vehicle and method can include a base, a sensor assembly adjacent the base, a garnish including at least one doghouse and covering the base and the sensor assembly, and at least one fastener or bolt. The at least one fastener/bolt can be fixed to the at least one doghouse and passes through the base. The at least one fastener/bolt can be configured to pass through the roof of the vehicle if/when the image sub-assembly is mounted onto the roof. Thus, a user can tighten, clamp or attach the imaging sub-assembly to the roof from a position inside the vehicle.

### BACKGROUND

The disclosed subject matter relates to an imaging sub-assembly for a vehicle. More particularly, the disclosed subject matter relates to methods and apparatus that facilitate assembling an imaging device onto the vehicle.

A vehicle can include one or more imaging devices such as, but not limited to, a radar, a camera, a sonar and a lidar. The imaging device(s) can provide data to a controller and the controller can create a map of the environment around the vehicle. The imaging device(s) can be mounted on any appropriate portion of the vehicle that can provide an observational view that allows an efficient and accurate map of the environment around the vehicle.

The imaging device(s) can be used for an automated driving assist system (also referred to as ADAS) such as, but not limited to, a blind-spot object detection system, a lane keep assist system (also referred to as LKAS), automatic cruise control (also referred to as ACC), autonomous driving system, or an automatic braking system.

The imaging device(s) can be mounted on a self-driving vehicle (also referred to as an automated vehicle or an AV). The controller can be configured to adjust the vehicle's trajectory based on the image data so that the vehicle can safely negotiate obstacles and avoid other vehicle(s) on the travel path.

### SUMMARY

Some embodiments are directed to an imaging sub-assembly for a vehicle including a roof member. The imaging sub-assembly can include: a base; a sensor assembly adjacent the base; a garnish including at least one doghouse and covering the base and the sensor assembly; and at least one bolt. The at least one bolt can be fixed to the at least one doghouse and passes through the base. The at least one bolt can be configured to pass through the roof member if/when the image sub-assembly is mounted onto the roof member.

Some embodiments are directed to a LiDAR sub-assembly for a vehicle including a roof member. The LiDAR sub-assembly can include: a LiDAR base; a LiDAR sensor assembly connected onto the LiDAR base; a garnish including a plurality of doghouses and covering the LiDAR base and the LiDAR sensor assembly; and a plurality of first bolts. Each of the first bolts can be fixed to a respective one of the doghouses and extends through the LiDAR base. Each of the first bolts can be configured to pass through the roof member if/when the LiDAR sub-assembly is mounted onto the roof member.

Some embodiments are directed to a method of assembling a LiDAR subassembly onto a vehicle. The method can include: providing a LiDAR base, a LiDAR sensor assembly, and a garnish including a plurality of doghouses; mounting the LiDAR sensor assembly onto the LiDAR base; fixing at least one fastener in a doghouse of the garnish; passing the at least one fastener, through the LiDAR base; placing a securing structure onto the at least one fastener and securing the securing structure against the LiDAR base to form the LiDAR subassembly; mounting the LiDAR sub-assembly as a completed unit onto a roof member of the vehicle such that the at least one fastener passes through a hole in the roof member of the vehicle; and placing a second securing structure onto the at least one fastener from inside of the vehicle and securing the second securing structure against the roof member from the inside of the vehicle.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective exploded view of an imaging sub-assembly made in accordance with principles of the disclosed subject matter.

FIG. 2 is a schematic cross-sectional view along line 2-2 of FIG. 1.

FIG. 3 is a perspective view of the imaging sub-assembly of FIG. 1 being mounted onto a vehicle.

FIG. 4 is a schematic cross-sectional view along line 4-4 of FIG. 3.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An imaging system can include a plurality of components including, but not limited to, a mounting member, a printed circuit board, one or more imaging sensors, and one or more covering panels. The covering panel(s) can form an exterior surface of the vehicle and can enclose the remaining components in a space that is sealed from the exterior environment. Each of the plurality of components can be mounted onto the vehicle, one-by-one, with the covering panel(s) being last in the assembling sequence. This can cause a relatively long cycle time to complete on a mass-production assembly line.

It can be advantageous to mount at least one imaging device on the roof of the vehicle because the field of view can be unobstructed by other portions of the vehicle. However, some vehicles can be relatively large in height and/or width such that it can be difficult for a worker to reach the mounting location(s) in a comfortable manner. A raised platform can be installed along the assembly line to ease the worker's reach. However, it is possible that the worker might feel a degree of discomfort even on a raised platform due the width and/or height of the vehicle.

In order to avoid discomfort or reduce the discomfort that might be experienced by the worker, a jig or lift assist can be installed along the assembly line. However, such an installation can involve an additional investment and maintenance for the jig or lift assembly.

Thus, there is a need for an imaging system that can be easily installed onto a vehicle, avoids or reduces worker discomfort, and avoids or reduces additional investment and maintenance for the assembly line.

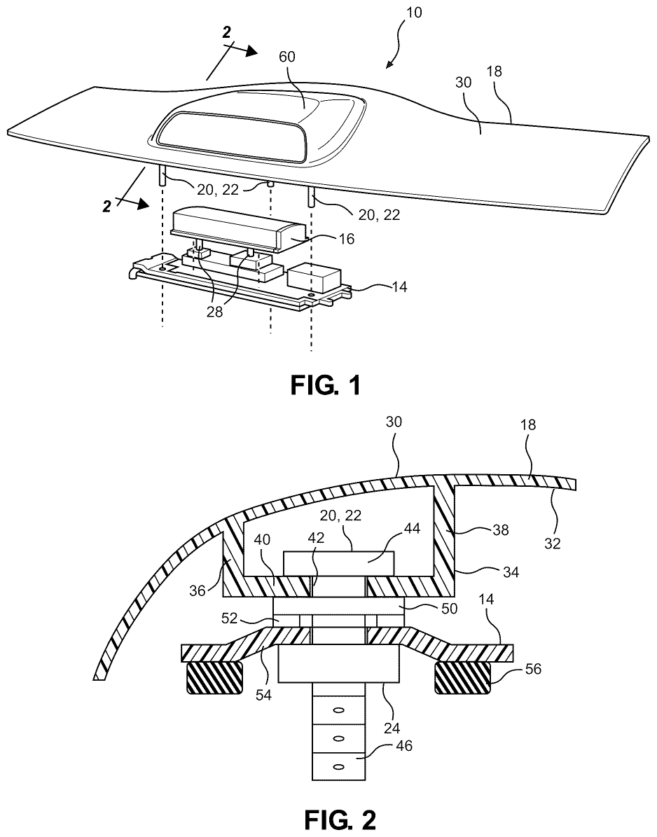

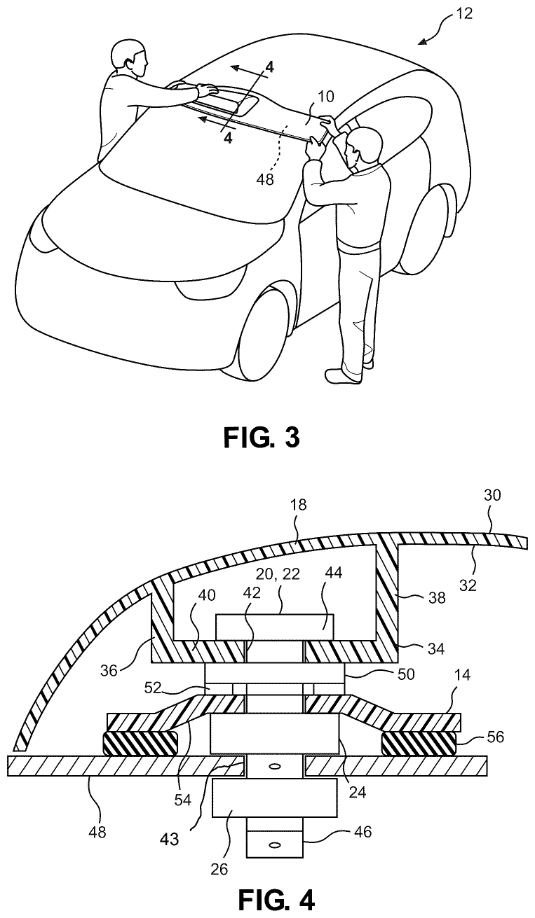

FIG. 1 illustrates an embodiment of an imaging sub-assembly 10 made in accordance with principles of the disclosed subject matter. The imaging sub-assembly 10 can include any appropriate imaging device such as, but not limited to a radar, a camera, a sonar, or a lidar, or any combination of these devices. The imaging sub-assembly 10 can be pre-assembled prior to mounting onto a vehicle 12 (FIG. 3) and mounted as a single unit onto the vehicle 12. As shown in FIG. 3, two workers can install the imaging sub-assembly 10 onto the vehicle 12—one at each end. This can avoid or minimize discomfort to the workers and reduce cycle time for installing the imaging sub-assembly 10 onto the vehicle 12.

Returning to FIG. 1, the imaging sub-assembly 10 can include a base 14, a sensor assembly 16, a garnish 18 and at least one first fastener 20 that is fixed to the garnish 18 and passes through the base 14. The imaging sub-assembly 10 can include a housing 60 that extends upward from an outer surface 30 of the garnish 18 such that the imaging device(s) (e.g., LiDAR, radar, sonar, and/or cameras and associated electronic components) can be perched on a roof of the vehicle 12 in a manner such that the imaging device has a good perspective view of the area surrounding the vehicle 12.

As shown in FIG. 4, the imaging sub-assembly 10 can include a plurality of first fasteners 20, and the first fasteners 20 can pass through a roof member 48 of the vehicle 12 such that the sub-assembly as a unit can be easily attached to the vehicle 12. Each of the first fasteners 20 can be any appropriate structure such as, but not limited to, a threaded bolt and nut, a rivet, a clip, a clamp, flex posts, or a screw. FIGS. 1, 2 and 4 depict the first fastener 20 as a threaded bolt 22 and a pair of nuts 24, 26. The second nut 26 is shown in FIG. 4. The sub-assembly 10 can be pre-assembled prior to arrival on the assembly line used to assemble the vehicle 12.

Referring to FIG. 1, the sub-assembly 10 can include at least one second fastener 28 that connects the sensor assembly 16 to the base 14. The second fastener 28 can be any appropriate structure such as, but not limited to, a threaded bolt and nut, a rivet, a clip, a clamp, a screw, a weld or an adhesive.

Referring to FIG. 2, the garnish 18 can include an outer surface 30, and inner surface 32 and a respective doghouse 34 for each of the first fastener(s) 20. The doghouse 30 can include a pair of side walls 36, 38, a connection wall 40 and a slot 42. The side walls 36, 38 can be connected to and protrude from the inner surface 32. The connection wall 40 can be connected to and extend from each of the side walls 36, 38.

The slot 42 can include an opening in the edge of the connection wall 40 that can allow the first fastener 20 to be inserted into the slot 42. The opening of the slot 42 can be smaller than a corresponding dimension (or width) of the first fastener 20. For example, the connection wall 40 can include a pair of resilient arms that extend across at least a portion of the slot to form the opening. During installation, the first fastener 20 can resiliently deflect the arms to increase the size of the opening so that the first fastener 20 can fully enter the slot 42. The arms can elastically return to their original positions after the first fastener 20 is fully inserted into the slot 42 and retain the first fastener 20 in the slot 42.

The threaded bolt 22 can include a head 44 and a threaded shaft 46. The head 44 can be dimensioned to be larger than the slot 42 so that it can be retained in a space between the connection wall 40 and the inner surface 32 of the garnish 18. The shaft 46 can be connected to and protrude from the head 44. As shown in FIG. 4, the shaft 46 can pass through the base 14 and a roof member 48 of the vehicle 12. Thus, the threaded bolt 22 can be referred to as a pass-through fastener.

The roof member 48 can be any appropriate structure of the roof such as, but not limited to, a front roof rail or a reinforcement panel. The front roof rail can also be referred to as a windshield header.

The threaded bolt 22 can include a collar 50 that is connected to the shaft 46 and spaced away from the head 44. The collar 50 can abut the connection wall 40 during installation of the imaging sub-assembly onto the roof member 48 so that the first fastener 20 does not retract into the space between the head 44 and the inner surface 32 of the garnish 18.

The first nut 24 can be threaded onto the threaded shaft 46 and tightened against the base 14. The imaging sub-assembly 10 can include at least one lock washer 52 one for each of the threaded bolt(s) 22. The lock washer 52 can resist rotation of the threaded bolt 22 during the tightening of the first nut 24. The second nut 26 can be threaded onto the shaft 46 and tightened against the roof member 48. As a result, the roof member 48 can be clamped between the first nut 24 and the second nut 26.

The base 14 can include a respective concavity 54 for each threaded bolt 22. The concavity can 54 can have any appropriate shape such that at least a portion of the second nut 26 can be located in the concavity 54 and firmly abut the base 14. The concavity 54 can reduce an amount that the imaging sub-assembly 10 protrudes away from the roof member 48 as compared to an imaging sub-assembly 10 that does not include the at least one concavity 54.

The imaging sub-assembly 10 can include a seal 56 that extends around a perimeter of the base 14. The seal 56 can be secured to the base by any appropriate structure such as, but not limited to, a mechanical fastener, welding, adhesive or any combination or number of these structures.

If the imaging sub-assembly 10 includes a lidar, the imaging sub-assembly can be referred to as a lidar sub-assembly, a lidar sensor assembly or a lidar system. Lidar can also be referred to as light detecting a ranging, laser imaging, detecting and ranging, LiDAR, or LIDAR.

An exemplary method of assembling the above described LiDAR subassembly 10 onto a vehicle can include providing (or pre-assembling) the LiDAR subassembly 10, and then attaching the LiDAR subassembly 10 to the roof member 48 of the vehicle 12.

The LiDAR subassembly 10 can be pre-assembled by providing a LiDAR base 14, a LiDAR sensor assembly 16 that includes the LiDAR itself (and/or other cameras, sensors, and related electronic components that include printed circuit boards, controllers, etc.), and a garnish 18 that can include a plurality of doghouses 34. The LiDAR sensor assembly 16 can be affixed to the LiDAR base 14 by connecting at least one first fastener 20 or bolt 22 into a respective doghouse 34 of the garnish 18, passing the at least one fastener/bolt 20/22, through the LiDAR base 14, and then threading a first nut 24 or other attachment clamp, adhesive, or structure onto the at least one fastener/bolt 20/22 and tightening (or clamping or otherwise securing) the first nut 24 (or other structure/material) against the LiDAR base 14 to form the LiDAR subassembly 10. The LiDAR sub-assembly 10 can then be mounted as a completed unit onto a roof member 48 of the vehicle 12 such that the at least one fastener/bolt 20/22 passes through a hole 43 in the roof member 48 of the vehicle. The method can then include threading a second nut 26 (or securing a second clamp, attachment structure, or adhesive material) onto the at least one fastener/bolt 20/22 from inside of the vehicle 12 and tightening (or clamping or otherwise securing) the second nut 26 (or attachment structure or material) against the roof member from the inside of the vehicle 12.

While certain embodiments of the invention are described above, it should be understood that the invention can be embodied and configured in many different ways without departing from the spirit and scope of the invention.

Instead of on the roof of the vehicle 12, alternate embodiments of the imaging sub-assembly 10 can be mounted onto any appropriate portion of the vehicle 12 such as, but not limited to, a front grille, a front bumper, a hood, a front fender, rear fender, a trunk, a tailgate, or a liftgate. The vehicle can also be shaped in various manners, such as cube shaped, elongate, symmetrical, or non-symmetrical.

The base 14 is shown in FIGS. 2 and 4 as being made from a plastic material. However, alternate embodiments can include a base 14 that is made from any appropriate material such as, but not limited to, metal, metal alloy, ceramic, carbon fiber, fiber reinforced plastic, fiberglass, or any combination of these materials.

The garnish 18 is shown in FIGS. 2 and 4 as being made from a plastic material. However, alternate embodiments can include a garnish 18 that is made from any appropriate material such as, but not limited to, metal, metal alloy, ceramic, carbon fiber, fiber reinforced plastic, fiberglass, or any combination of these materials.

The vehicle 12 of FIG. 3 is configured as a passenger vehicle. However, the disclosed vehicle 12 can be configured for travel along any one or combination of improved, unimproved, and unmarked paths. For example, embodiments are intended to include or otherwise cover any type of automobile, including a passenger car, minivan, pick-up truck, delivery truck, all-terrain vehicle (ATV), semi-tractor, off-highway vehicle, construction vehicle. watercraft, ship, submarine, spacecraft, etc.

What is claimed is:

1. An imaging sub-assembly for a vehicle including a roof member, comprising:
a base;
a sensor assembly adjacent the base;
a garnish including at least one doghouse and covering the base and the sensor assembly; and
at least one fastener, the at least one fastener is fixed to the at least one doghouse and passes through the base, the at least one fastener is configured to pass through the roof member if the image sub-assembly is mounted onto the roof member.

2. A method of assembling the imaging sub-assembly according to claim 1 onto a vehicle, the method comprising:
placing the imaging sub-assembly onto an outer side of a roof member of the vehicle so that the at least one fastener passes through a mating hole in the roof member; and
threading a nut onto the at least one fastener and tightening the nut against the roof member.

3. The method according to claim 2, wherein the threading the nut includes threading the nut from inside of the vehicle.

4. The imaging sub-assembly according to claim 1, wherein the sensor assembly includes any one of a LiDAR, a camera, a radar, and a sonar.

5. The imaging sub-assembly according to claim 1, further comprising:
a first nut thread onto the at least one fastener and tightened against the base.

6. The imaging sub-assembly according to claim 5, wherein the base includes a concavity and the first nut is located in the concavity.

7. The imaging sub-assembly according to claim 6, further comprising:
a seal encircling the base, the seal is configured to abut the roof member if the imaging sub-assembly is mounted onto the roof member, wherein
the seal, the recess and the roof member bound a space that contains the first nut; and
the garnish completely covers and encloses the base and the sensor assembly.

8. The imaging sub-assembly according to claim 1, further comprising:
a second nut threaded onto the at least one fastener and configured to be tightened against the roof member such that the roof member is located between the first nut and the second nut.

9. The imaging sub-assembly according to claim 1, wherein
the garnish includes:
an outer surface that forms a portion of an exterior surface of the vehicle if the imaging sub-assembly is mounted onto the roof member; and
an inner surface that opposes the roof member if the imaging sub-assembly is mounted onto the roof member,
the doghouse includes:
a pair of side walls that are connected to and protrude from the inner surface; and
a connection wall that is connected to and extends from each of the side walls, the connection wall includes a through hole, and
the at least one fastener extends through the through hole.

10. The imaging sub-assembly according to claim 1, wherein the at least one fastener includes:
a head;
a shaft connected to and protruding from the head; and
a collar connected to the shaft and spaced away from the head.

11. The imaging sub-assembly according to claim 1, wherein
the garnish includes:
an outer surface that forms a portion of an exterior surface of the vehicle if the imaging sub-assembly is mounted onto the roof member; and
an inner surface that opposes the roof member if the imaging sub-assembly is mounted onto the roof member,
the doghouse includes:
a pair of side walls that are connected to and protrude from the inner surface; and
a connection wall that is connected to and extends from each of the side walls, the connection wall includes a through hole, and
the at least one fastener extends through the through hole, and the at least one fastener includes:
a head;
a shaft connected to and protruding from the head; and
a collar connected to the shaft and spaced away from the head, wherein the connection wall is located between the head and the collar.

12. The imaging sub-assembly according to claim 1, further comprising:
a second fastener connecting the sensor assembly to the base, the second fastener is spaced away from the roof member if the imaging sub-assembly is mounted onto the roof member.

13. A LiDAR sub-assembly for a vehicle including a roof member, comprising:
a LiDAR base;
a LiDAR sensor assembly connected onto the LiDAR base;
a garnish including a plurality of doghouses and covering the LiDAR base and the LiDAR sensor assembly; and
a plurality of first fasteners, each of the first fasteners is fixed to a respective one of the doghouses and extends through the LiDAR base, each of the first fasteners is configured to pass through the roof member if the LiDAR sub-assembly is mounted onto the roof member.

14. The LiDAR sub-assembly according to claim 13, wherein
the garnish includes:
an outer surface that is configured to form a portion of an exterior surface of the vehicle member if the LiDAR sub-assembly is mounted onto the roof member; and
a housing that protrudes from the outer surface,
the housing and the LiDAR base form a space and the LiDAR sensor assembly is in the space.

15. The LiDAR sub-assembly according to claim 13, further comprising:
a plurality of second fasteners that connect the LiDAR sensor assembly to the LiDAR base.

16. The LiDAR sub-assembly according to claim 13, wherein
each of the first fasteners includes a head, a shaft connected to and extending from the head, and a collar connected to the shaft and spaced away from the head, the head, shaft, and collar are concentric with each other when viewed along a longitudinal axis of the shaft, and
a portion of the doghouse is captured between the head and the collar.

17. A vehicle comprising:
the LiDAR sub-assembly according to claim 13;
a pair of A-pillars; and
a roof front rail connected to and extending from each of the A-pillars, wherein
the roof front rail is the roof member, and
the garnish includes a front edge that extends along the roof front rail.

18. The vehicle according to claim 17, further comprising:
a plurality of first nuts, each of the first nuts is threaded onto a respective one of the first fasteners and tightened against the LiDAR base; and
a plurality of second nuts, each of the second nuts is threaded onto a respective one of the first fasteners and tightened against the roof front rail, wherein
the roof front rail is located between the first nuts the second nuts.

19. The vehicle according to claim 18, further comprising:
a plurality of seals, each of the seals surrounds a respective one of the first fasteners and a respective one of the first nuts, and each of the seals abuts the roof front rail.

20. A method of assembling a LiDAR subassembly onto a vehicle comprising:
providing a LiDAR base, a LiDAR sensor assembly, and a garnish including a plurality of doghouses;
mounting the LiDAR sensor assembly onto the LiDAR base;
fixing at least one fastener in a doghouse of the garnish;
passing the at least one fastener, through the LiDAR base;
placing a securing structure onto the at least one fastener and securing the securing structure against the LiDAR base to form the LiDAR subassembly;
mounting the LiDAR sub-assembly as a completed unit onto a roof member of the vehicle such that the at least one fastener passes through a hole in the roof member of the vehicle; and
placing a second securing structure onto the at least one fastener from inside of the vehicle and securing the second securing structure against the roof member from the inside of the vehicle.
